(19) United States
(12) Patent Application Publication
(10) Pub. No.: US 2011/0043125 A1
(43) Pub. Date: Feb. 24, 2011

(54) LED DRIVING UNIT

(75) Inventor: Henricus Marie Peeters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/990,651

(22) PCT Filed: Apr. 29, 2009
(86) PCT No.: PCT/IB09/51734

§ 371 Date: Nov. 2, 2010

(30) Foreign Application Priority Data
May 6, 2008 (EP) 08155671.4

(51) Int. Cl. H05B 37/02

(52) U.S. Cl. 315/287; 315/297

(57) ABSTRACT

A daisy chain dimming solution can be applied in all kinds of LED driver topologies. A central idea is to measure or sense the current levels or pulse width modulation duty cycles in a previous segment (N−I) in a chain of segments of LED driving units with associated LED strands, and control the current through the next segment (N) based on the sensed current through the previous. For example, each LED driving unit (10) can copy the same dimming level to the next segment, and in this way the same dimming can be obtained for several segments without the need for separate cabling for distributing a dimming signal.

### FIELD OF THE INVENTION

The present invention relates to a LED driving unit for supplying a current to a strand of at least one LED, the unit comprising a control block, power input terminals for feeding power to the control block, and output terminals through which the control block is adapted to supply said current.

### BACKGROUND OF THE INVENTION

US 2003/0227265 A1 discloses a drive circuit for a LED strand of the type referred to above, wherein the drive circuit enables pulse width modulation dimming of the LED strands by supplying a control signal to the drive circuit, the control signal indicating a desired, nominal average LED strand current.

In larger LED lighting configurations comprising several LED driving units, each of which provides current to one or several LED strands, a simultaneous uniform dimming of several of the LED strands is often desired.

Large LED systems tend to be complex and involve many connections. They are therefore also often more complicated to control than smaller LED systems.

### SUMMARY OF THE INVENTION

It is an object of the present invention to overcome or at least mitigate this problem, and to provide a LED driving unit that makes it easier to design, assemble, or control LED systems involving a plurality of LED strands.

With the foregoing and other objects in view, there is provided a LED driving unit for supplying a second current to a second strand of at least one LED, the unit comprising a control block; power input terminals for feeding power to the control block; and output terminals through which the control block is adapted to supply said second current, the unit being characterized in that the LED driving unit comprises a sensing device for sensing a first current through a first strand of at least one LED; and that the control block is adapted to control said second current based on said first current.

Thanks to the invention, it is possible to use the current level of the first segment for obtaining a control signal to another segment. This reduces the need for providing separate cabling for sending control signals to all segments.

Particularly, this may be a benefit when using ribbon cable to connect several driving units in parallel, as more conductors would otherwise be required in the ribbon cable for interconnecting a chain of dimmable segments than a chain of non-dimmable segments. In this disclosure, the term segment designates a set of a LED driving unit and the LED strand that the LED driving unit provides current to. Having different numbers of conductors to dimmable and non-dimmable products increases the need for different mechanical architectures of modules in dimmable and non-dimmable product lines. A lower number of different mechanical architectures may result in lowered costs for development, production, logistics, and/or stock-keeping.

In one embodiment, the control block is arranged to control said second current to have a mean value, with respect to time, that deviates from the time average of said first current by less than 15%. By providing a current level to the second strand that does not deviate too much from the level of the current through the first strand, it is possible to connect more than two segments in series with maintained dimming function. Preferably, the time average of said second current corresponds to the time average of said first current. This may allow an essentially unlimited number of segments inter-operating for daisy-chain dimming. Also, in RGB LED systems, controlling the current levels between segments is important to maintain a constant color point between segments.

In one embodiment, the LED driving unit is arranged to supply a second current pulse to said second strand of LEDs based on the detection of a first current pulse through said first strand of LEDs. This embodiment is particularly well suited for LED driving units supplying a pulse width modulated current to a LED strand.

Preferably, the LED driving unit is configured to de-synchronize said second current pulse with respect to said first current pulse. By de-synchronizing the pulses, said first and second LED strands will not simultaneously start to consume electrical power from any power source their respective driving units share. In this way, surge currents and electromagnetic interference may be reduced, and it may also be possible to select a shared power supply having a lower maximum power rating.

One way to configure the LED driving unit to de-synchronize said second current pulse with respect to said first current pulse is by using a time delay device, arranged to delay said second current pulse with respect to said first current pulse by a fixed delay. Preferably, the time delay is at least 10 μs, and more preferred, at least 50 μs, in order to assure a minimum of ripple on the powerline.

Another way to configure the LED driving unit to de-synchronize said second current pulse with respect to said first current pulse is by using a time delay device, arranged to delay said second current pulse with respect to said first current pulse by a random delay.

In one embodiment, said first and second currents are pulsed, and the average current level of said second current with respect to time is controlled by controlling the average pulse amplitude, the average pulse frequency, and/or the average pulse length from a random pulse source. By correlating the characteristics of the pulsing of said second current to the characteristics of the pulses from a random pulse source, an efficient de-synchronization of the pulses of said first and second currents may be obtained.

In one embodiment, the control block is arranged to control said second current to have a peak value that corresponds to the peak value of said first current. Using this configuration it is possible to copy the optical wavelength emitted by one segment to another.

In one embodiment, said sensing device comprises a resistor, which is connected in series with said first LED strand, and a measuring device for measuring a voltage level across said resistor. This embodiment is particularly well suited for dimming using analog current level control.

It is not necessary that each LED strand of a daisy-chain comprise the same number of LEDs; the number of LEDs of each segment may vary while still maintaining proper dimming control.

### BRIEF DESCRIPTION OF THE DRAWINGS

This and other aspects of the present invention will now be described in more detail, with reference to the appended drawings showing a currently preferred embodiment of the invention.

FIG. 1 shows an example of a general layout of a LED driving unit.

FIG. 2 is a wiring diagram illustrating a chain of two instances of the LED driving unit of FIG. 1, each unit driving a strand of LEDs.

FIG. 3 is a circuit diagram of a PWM LED driving unit with dimming capability.

FIG. 4A is a set of graphs, illustrating synchronized PWM LED driving.

FIG. 4B is a set of graphs, illustrating unsynchronized PWM LED driving.

FIG. 5 is a circuit diagram of a PWM LED driving unit with dimming capability.

FIG. 6 is a circuit diagram of a LED driving unit with current level dimming capability.

### DETAILED DESCRIPTION

Operating light emitting diodes, LEDs, requires special care, as electrical power is often available as a constant voltage, and LEDs require a controlled current. This is typically taken care of by a LED driving unit, which converts a voltage to a well defined, constant or variable, current. Several LEDs, powered by a single LED driving unit, are often connected in series to form strings or strands, and several LED driving units, each providing several LEDs with current, may be connected in parallel to a single voltage supply.

The amount of light emitted from a strand of LEDs is controlled by the LED driving unit, which typically changes the optical output level by changing the level of a continuous current through the strand, or by pulse width modulation, PWM. Using PWM it is possible to change the average current through the strand without changing the peak current, which enables dimming of the LEDs without changing the strongly current-depending wavelength of the emitted light.

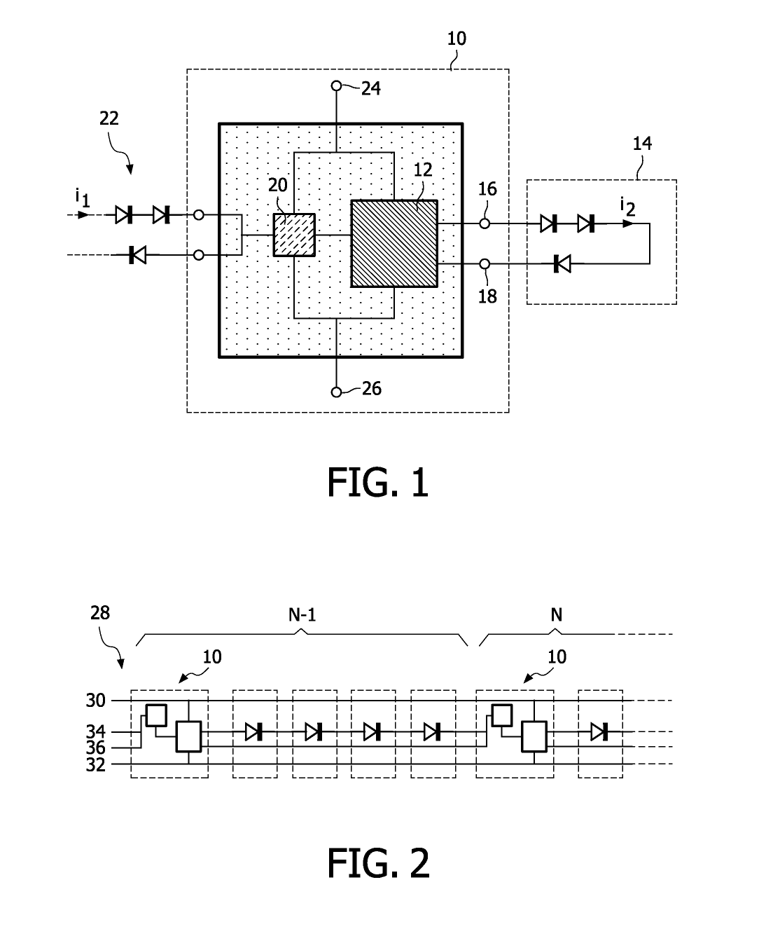

FIG. 1 shows a LED driving unit 10, comprising a control block 12 that provides a current i₂ through a second strand 14 of three LEDs via terminals 16, 18. A sensing device 20 detects the current i₁ through a first strand 22 of LEDs, and provides a dimming signal to the control block 12. The entire unit is powered by a voltage supplied from a voltage source via power input terminals 24, 26.

FIG. 2 illustrates a chain of multiple LED driving units, each unit being identical to the LED driving unit 10 of FIG. 1, and providing an electrical current to a strand of LEDs. In this example, only two segments N and N−1 of a LED driving unit and a LED strand are shown, although the chain may comprise a high number of segments. The two segments shown in the figure are identical, even though strand N is not shown in its entirety. The dashed rectangles illustrate an example of a separation into physical modules of the driving units and the LEDs.

The LED driving units are configured for daisy chain dimming; i.e., the dimming level of strand N is controlled by LED driving unit N based on the dimming level of strand N−1. In this manner, for a daisy chain comprising a high number of LED driving units, it is only necessary to provide a dimming level control signal to the first LED driving unit in the chain (not shown). All other LED driving units receive their dimming signal from the previous LED strand in the chain. The modules are connected via pieces of flat ribbon cable 28, the cable 28 comprising four leads: two leads 30, 32 for providing electrical power to the LED driving units, and two leads 34, 36 for the LED strand circuit. The two LED strand leads 34, 36 of LED strand N−1 are closed to a circuit loop inside the driver module of segment N. The last LED strand (not shown) of the daisy chain may be closed with a terminating module, merely closing the two leads 34, 36.

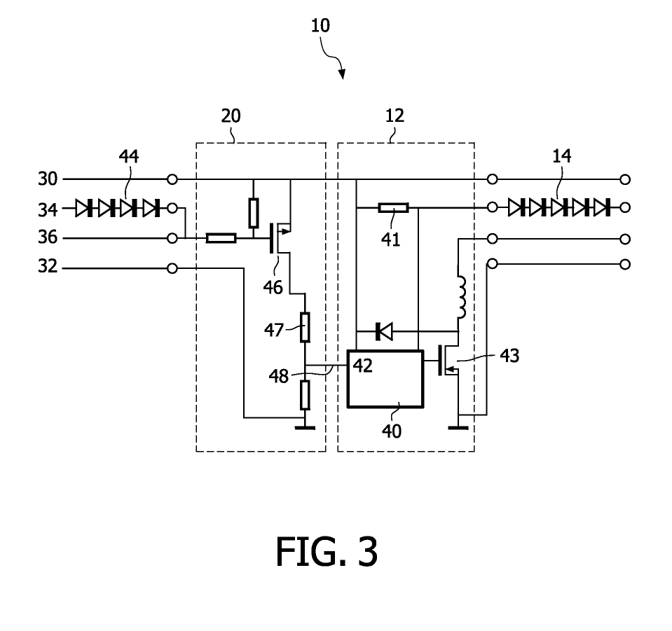

The circuit diagram of FIG. 3 illustrates an example of an implementation of the LED driving unit 10 of FIG. 1. This LED driving unit implementation is particularly well suited for PWM dimming. It comprises a current provision portion 12 for providing a PWM current to the LED strand 14, and a current sensing portion 20 for sensing the presence of a PWM current through the LED strand 44. Via a lead 48, the current sensing portion 20 provides a control signal to the current provision portion 12.

Different implementations of the current provision portion 12 should be familiar to those skilled in the art; in this example it is implemented as a buck converter. Also other current sources, such as boost converters, Cuk converters, flyback converters, etc, may be used. A control IC 40 measures the voltage across and current through a shunt resistor 41, and controls the current through the LED strand 14 by switching an n-channel MOSFET 43. An input pin 42 of the control IC 40 allows switching on the current provided to the LED strand 14. The current sensing portion 20 of the LED driving unit 10 comprises a p-channel MOSFET 46, and a number of resistors. When there is a current through LED strand 44, the voltage on the gate of the p-channel MOSFET 46 is low, and the p-channel MOSFET 46 connects the enable pin 42 of the IC 40, via a divider resistor 47, to the supply voltage of lead 30. The high potential at the enable pin 42 keeps the current to LED strand 14 switched on, i.e. the modulation of the current provided to the LED strand 14 follows the pulse width modulated current through LED strand 44. The absence of a current through the LED strand 44 will raise the potential at the p-channel MOSFET's 46 gate, breaking the connection via MOSFET 46 between the lead 30 and the pin 42, and lowering the potential of the enable input pin 42. This will result in the current to LED strand 14 being switched off.

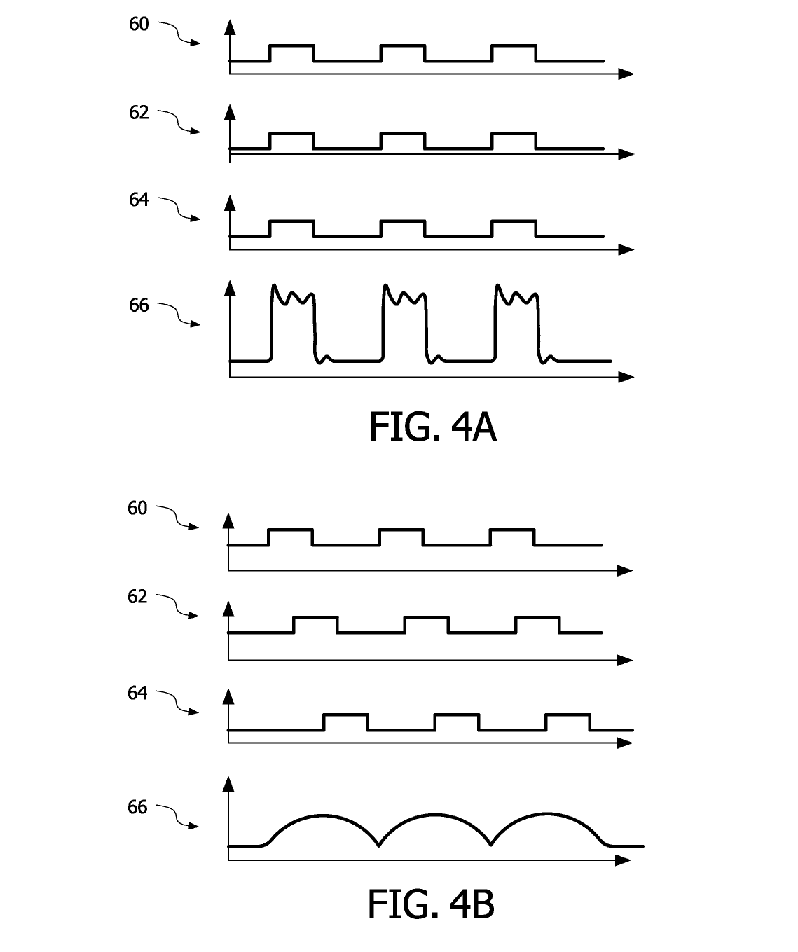

By adding a delay function in a manner well known per se to the control IC 40, additional benefits are obtained. The three top graphs 60, 62, 64 of FIG. 4A illustrate the PWM current, versus time, provided by three separate LED driving units. In this case, all three LED driving units are receiving the same PWM dimming signal in parallel. The PWM dimming signal controls the pulsing of the current from the LED driving units, and the current pulses will therefore be synchronized. Graph 66 illustrates the total current supplied to all three LED driving units. It features a high peak current, and significant ringing due to large surge currents in the supply line to the units.

FIG. 4B shows the same currents as FIG. 4A, but for a configuration wherein the PWM current pulses are de-synchronized. Thanks to the de-synchronization, the PWM current pulses are spread in time, and the supply peak current and surge currents are therefore significantly reduced. In this example, de-synchronization is obtained by having a delay function in the control IC 40 of each LED driving unit 10. And, as each LED driving unit N along the daisy chain adds a time delay to the pulse detected from LED driving unit N−1, there is no need to provide each driving unit with any individual, pre-set delay time, or any individual de-synchronization signal.

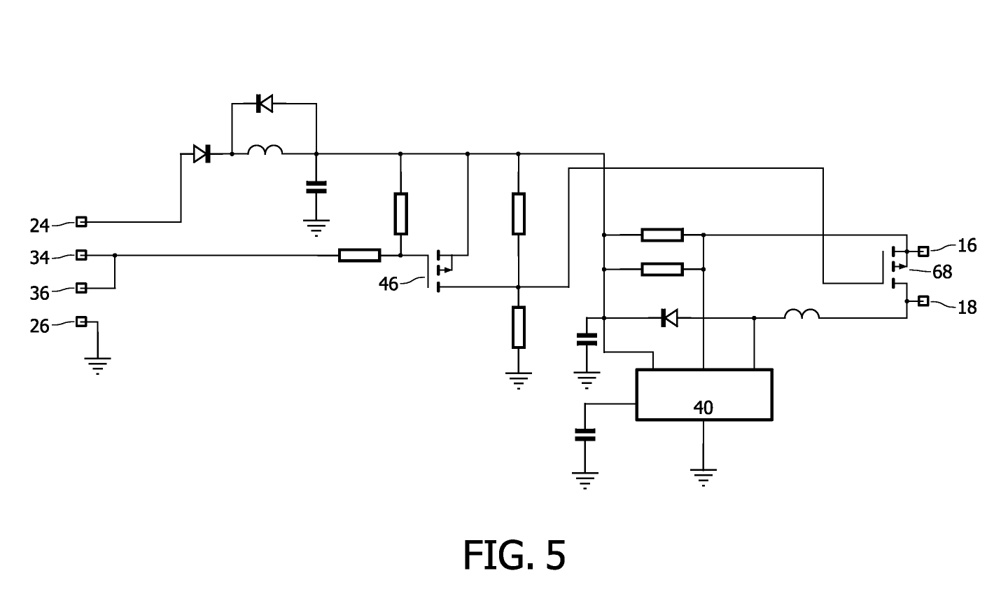

FIG. 5 is another diagram of a circuit capable of performing PWM dimming. Here, like in FIG. 3, the p-channel MOSFET 46 works as an inverter. The function of the LED driving unit described by this diagram differs from the function of the LED driving unit in the diagram of FIG. 3 mainly in that the enable signal from the p-channel MOSFET 46 is not used to control the switching signal from the control IC 40 to the n-channel MOSFET 43. Instead, when the enable signal gets low, it breaks the current through the LED strand by short-circuiting a third MOSFET 68. When MOSFET 68 is shorted, the current source will adapt the output voltage to a very low value; so despite the fact that there is still current flowing, the power consumption in the off state will be low. Maintaining a current when in the off state is beneficial from an EMI point of view.

Another difference is that the switching MOSFET denoted 43 in FIG. 3 is built into the control IC 40 of FIG. 5.

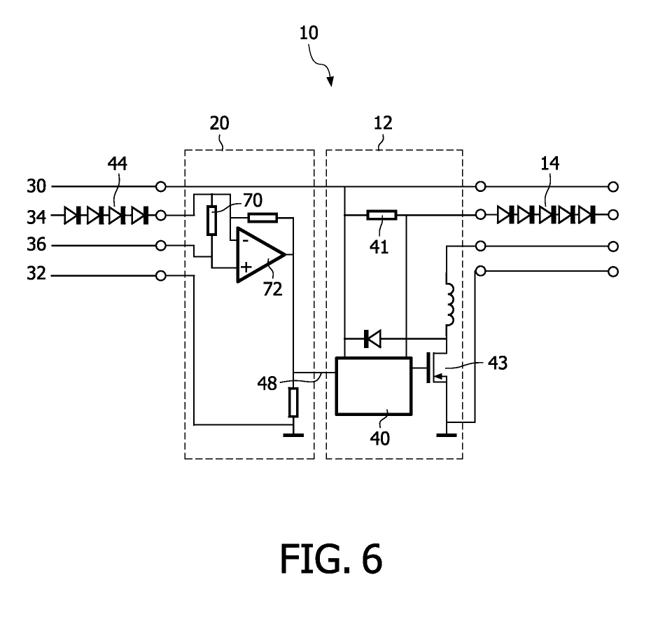

The circuit diagram of FIG. 6 illustrates an example of an implementation of the LED driving unit 10 of FIG. 1. This implementation is particularly well suited for current level dimming, i.e. dimming by means of controlling the current level rather than the current duty cycle, even though it may be successfully used for duty cycle dimming as well. It comprises a current provision portion 12 for providing a current to the LED strand 14, and a current sensing portion 20 for measuring the current through the LED strand 44. Via a lead 48, the current sensing portion 20 provides a control signal to the current provision portion 12. In this example, the current sensing portion 20 of the LED driving unit comprises a shunt resistor 70 in series with the LED strand 44, and an operational amplifier 72 arranged to measure the voltage over, and hence the current through the shunt resistor 70. The output signal of the operational amplifier 72 is fed to a control IC 40 via lead 48, and the control IC 40 adjusts the level of the current through the LED strand 14 to the current value measured by the sensing portion 20.

Again, it should be stressed that this daisy chain dimming solution can be applied in all kinds of LED driver topologies. A central idea is to measure or sense the current levels or pulse width modulation duty cycles in a previous segment (N−1) in a chain of segments of LED driving units with associated LED strands, and control the current through the next segment (N) based on the sensed current through the previous. For example, each LED driving unit can copy the same dimming level to the next segment, and in this way the same dimming can be obtained for several segments without the need for separate cabling for distributing a dimming signal.

The person skilled in the art realizes that the present invention by no means is limited to the preferred embodiments described above. On the contrary, many modifications and variations are possible within the scope of the appended claims. For example, it is not necessary that the complete LED driving unit of claim 1 be comprised within the same physical module. Different parts of the unit may be separated between different modules, which, when connected, obtain the same function as claimed. Neither is the invention limited to LEDs emitting visible light, nor to LEDs emitting light in a broadband optical spectrum. Also narrow-band LEDs incorporating any type of optical feed-back and stimulated emission, such as diode lasers, are within the scope of the claim, as are LEDs emitting light in the IR and UV regions. The invention does not only apply to switch-mode drivers. Also linear drivers, such as dissipative or resistive drivers, may be used to implement the invention. Other means for sensing the current through a LED strand than those described in detail above may be used to implement the invention and are covered by the appended claims. By way of example, the current through a LED strand may be measured using a Hall sensor, or may be sensed indirectly by using a photodiode detecting the light emitted by the LED strand or a portion of it.

The reference signs in the claims are not intended to limit the scope, but are present to facilitate quicker understanding of the claims.

1-11. (canceled)

12. An LED driving unit for supplying a current to a strand comprising at least one LED, the unit comprising:
a sensing device for sensing a first current through a first strand comprising at least one first LED;
a control module;
power input terminals for connecting a power source to the control block; and
output terminals for supplying a second current to a second strand comprising at least one second LED, wherein the control module is configured to control said second current based on said first current.

13. The LED driving unit according to claim 12, wherein the control module is arranged to control said second current to have a mean value, with respect to time, that deviates from the time average of said first current by less than 15%.

14. The LED driving unit according to claim 13, wherein the control module is arranged to control said second current to have a mean value, with respect to time, that corresponds to the mean value of said first current.

15. The LED driving unit according to claim 12, wherein the unit is arranged to supply a second current pulse to said second strand based on the detection of a first current pulse through said first strand.

16. The LED driving unit according to claim 15, wherein the LED driving unit is configured to de-synchronize said second current pulse with respect to said first current pulse.

17. The LED driving unit according to claim 16, wherein the LED driving unit is configured to de-synchronize said second current pulse with respect to said first current pulse using a time delay device, arranged to delay said second current pulse with respect to said first current pulse by a fixed delay of at least 10 μs.

18. The LED driving unit according to claim 16, wherein the LED driving unit is configured to de-synchronize said second current pulse with respect to said first current pulse using a time delay device, arranged to delay said second current pulse with respect to said first current pulse by a random delay.

19. The LED driving unit according to claim 12, wherein said second current is pulsed, and its average with respect to time is controlled by controlling the average pulse amplitude, the average pulse frequency, or the average pulse length from a random pulse source.

20. The LED driving unit according to claim 12, wherein the control module controls said second current to have a peak value that corresponds to the peak value of said first current.

21. The LED driving unit according to claim 12, wherein said sensing device comprises a resistor connected in series with said first LED strand, and a measuring device for measuring a voltage level across said resistor.
